(19) United States
(12) Patent Application Publication
(10) Pub. No.: US 2025/0101229 A1
(43) Pub. Date: Mar. 27, 2025

(54) ASPHALT COMPOSITION FOR ROOFING APPLICATIONS

(71) Applicant: CERTAINTEED LLC, Malvern, PA (US)

(72) Inventors: Xiguo ZENG, Sudbury, MA (US); Amir Bahadori, Malvern, PA (US); Justin Minder, Wayne, PA (US); Julie Tinklenberg, Downingtown, PA (US); Travis Cohen, Marlborough, MA (US)

(21) Appl. No.: 18/891,380

(22) Filed: Sep. 20, 2024

Related U.S. Application Data
(60) Provisional application No. 63/584,406, filed on Sep. 21, 2023.

(51) Int. Cl. C08L 95/00; D06N 5/00; E04D 1/20

(52) U.S. Cl. CPC C08L 95/00; D06N 5/003; E04D 1/20; C08L 2205/035; C08L 2207/24; C08L 2555/22; C08L 2555/24; D06N 2201/082; D06N 2203/047; D06N 2205/18

(57) ABSTRACT

According to one aspect, an asphalt blend can include asphalt, a first polymer additive, and ground tire rubber having a mesh size greater than 80 mesh. The blend can be mixed with filler to prepare a filled asphalt mix. The blends and mixes may have a particular softening point or penetration at 115° F. that may provide improved performance or durability.

### CROSS-REFERENCE TO RELATED APPLICATION(S)

This application claims priority under 35 U.S.C. § 119 (e) to U.S. Provisional Patent Application No. 63/584,406, entitled “ASPHALT COMPOSITION FOR ROOFING APPLICATIONS,” filed Sep. 21, 2023, by Xiguo ZENG et al., which is assigned to the current assignee hereof and is incorporated herein by reference in its entirety.

### BACKGROUND

### Field of the Disclosure

The following is directed to asphalt compositions, and more particularly, filled asphalt mixes for roofing applications.

### SUMMARY

Asphalt blends can include asphalt, a polymer additive, and ground tire rubber. A filler may be added to the blends to provide filled asphalt mixes. The blends and mixes may have a particular softening point or penetration at 115° F. that may provide improved performance or durability.

### BRIEF DESCRIPTION OF THE DRAWINGS

The present disclosure may be better understood, and its numerous features and advantages made apparent to those skilled in the art by referencing the accompanying drawings.

FIG. 1 includes a process for preparing a filled asphalt mix.

FIG. 2 is a schematic top view of a pallet useful in various embodiments of the disclosure.

FIG. 3 is a schematic side view of the pallet of FIG. 2, loaded with bundles of shingles.

FIG. 4 is a schematic bottom view of the pallet of FIG. 2.

FIG. 5 is a schematic bottom view of another pallet useful in various embodiments of the disclosure.

FIGS. 6a and 6b include images of shinglets after non-adhesion testing.

### DETAILED DESCRIPTION

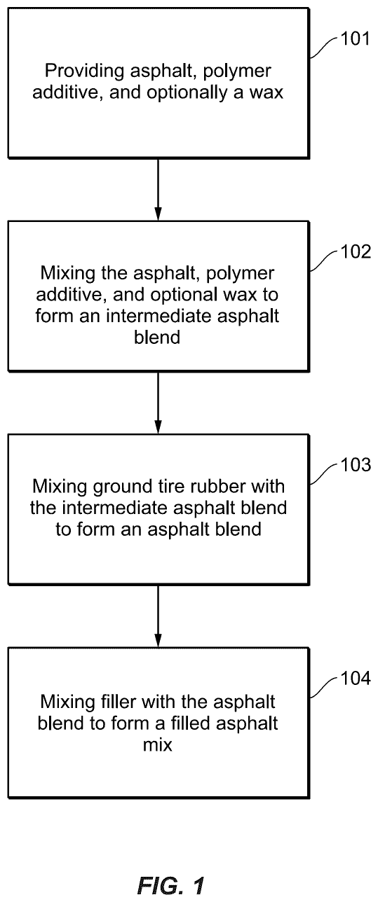

The following is directed to asphalt compositions. A process for preparing a filled asphalt mix 100 is shown in FIG. 1.

The process can begin with step 101, providing asphalt, polymer additive, and optionally a wax. The process can continue with step 102, mixing the asphalt, polymer additive, and optional wax to form an intermediate asphalt blend.

In an embodiment, mixing the intermediate blend may be done with high shear mixing. The high shear mixing may be done with a homogenizer or rotor stator mixer. High shear mixing can include mixing done with a shear rate of greater than 10,000 s⁻¹.

In an embodiment, the homogenizer or rotor stator mixer may be operated with a particular speed that may facilitate improved performance and/or manufacturing of the asphalt blends or mixes. In an embodiment, the homogenizer or rotor stator mixer may be operated with a speed of at least 2500 rpm or at least 2600 rpm or at least 2700 rpm or at least 2800 rpm or at least 2900 rpm or at least 3000 rpm. In an embodiment, the homogenizer or rotor stator mixer may be operated with a speed of no greater than 4500 rpm or no greater than 4400 rpm or no greater than 4300 rpm or no greater than 4200 rpm or no greater than 4100 rpm or no greater than 4000 rpm. It will be appreciated that the homogenizer or rotor stator mixer may be operated with any speed between any of the minimum and maximum values noted above, including for example, but not limited to, at least 3000 rpm and no greater than 4000 rpm or at least 2700 rpm and no greater than 4100 rpm.

In an embodiment, mixing the intermediate asphalt blend may be done at a particular temperature that may facilitate improved performance and/or manufacturing of the asphalt mix. In an embodiment, the mixing may be done at a temperature of at least 325° F. or at least 330° F. or at least 345° F. or at least 350° F. or at least 355° F. or at least 360° F. or at least 365° F. In an embodiment, mixing may be done at a temperature of no greater than 425° F. or no greater than 420° F. or no greater than 415° F. or no greater than 410° F. or no greater than 405° F. or no greater than 400° F. or no greater than 395° F. or no greater than 390° F. or no greater than 385° F. It will be appreciated that the mixing temperature may be between any of the minimum and maximum values noted above, including for example, but not limited to, at least 325° F. and not greater than 405° F. or at least 365° F. and not greater than 385° F.

In an embodiment, the asphalt may be a particular asphalt that may provide improved performance and or manufacturing of the asphalt blends and/or mixes. In an embodiment, the asphalt can include paving grade asphalt.

In an embodiment, the paving grade asphalt may have a high temperature performance grade of at least 46° C. or at least 52° C. or at least 58° C. or at least 64° C. or at least 70° C. or at least 82° C. In an embodiment, the paving grade asphalt may have a high temperature performance grade of not greater than 82° C. or not greater than 76° C. or not greater than 70° C. or not greater than 64° C. or not greater than 58° C. or not greater than 52° C. or not greater than 46° C. It will be appreciated that the high temperature performance grade of the paving grade asphalt may be between any of the minimum and maximum values noted above, including for example, but not limited to, at least 46° C. and not greater than 82° C. or at least 58° C. and not greater than 70° C.

In an embodiment, the paving grade asphalt may have a particular low temperature performance grade that may provide improved performance and or manufacturing of the asphalt mix. In an embodiment, the paving grade asphalt may have a low temperature performance grade of at least −46° C. or at least −40° C. or at least −34° C. or at least −28° C. or at least −22° C. or at least −16° C. or at least −10° C. In an embodiment, the paving grade asphalt may have a low temperature performance grade of not greater than −10° C. or not greater than −16° C. or not greater than −22° C. or not greater than −28° C. or not greater than −34° C. or not greater than −40° or not greater than −46° C. It will be appreciated that the low temperature performance grade of the paving grade asphalt may be between any of the minimum and maximum values noted above, including for example, but not limited to, at least −46° C. and not greater than −10° C. or at least −34° C. and not greater than −16° C.

In an embodiment, the paving grade asphalt can include PG 64-22 asphalt.

In an embodiment, the blend may have a particular asphalt content that may provide improved performance and/or manufacturing of the asphalt blends and/or mixes. In an embodiment, the blend can have an asphalt content of at least 70 wt. % for a total weight of the blend or at least 72 wt. % or at least 74 wt. % or at least 76 wt. % or at least 78 wt. % or at least 80 wt. % or at least 82 wt. % or at least 84 wt. % or at least 86 wt. % or at least 88 wt. % or at least 90 wt. % or at least 92 wt. % or at least 94 wt. %. In an embodiment, the blend can have an asphalt content of no greater than 99 wt. % for a total weight of the blend or no greater than 98 wt. % or no greater than 96 wt. % or no greater than 94 wt. % or no greater than 92 wt. % or no greater than 90 wt. % or no greater than 88 wt. % or no greater than 86 wt. % or no greater than 84 wt. % or no greater than 82 wt. % or no greater than 80 wt. %. It will be appreciated that the asphalt content may be between any of the minimum and maximum values noted above, including for example, but not limited to, at least 70 wt. % and not greater than 98 wt. % or at least 76 wt. % and not greater than 92 wt. %.

In an embodiment, the first polymer additive may have a particular composition that may facilitate improved performance and/or manufacturing of the asphalt blends and/or mixes. In an embodiment, the first polymer additive is a styrene-butadiene-styrene (sbs) polymer. The sbs polymer can be a linear sbs polymer, a radial sbs polymer, or a combination thereof.

In an embodiment, the sbs polymer can have a particular polybutadiene mid-block vinyl content that may facilitate improved performance and/or manufacturing of the asphalt blends and/or mixes. In an embodiment, the sbs polymer can have a vinyl content of at least 5% or at least 6% or at least 7% or at least 8% or at least 9% or at least 10% or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40%. In an embodiment, the sbs polymer can have a vinyl content of not greater than 75% or not greater than 60% or not greater than 50% or not greater than 45%. It will be appreciated that the vinyl content of the sbs polymer may be between any of the minimum and maximum values noted above, including for example, but not limited to, at least 25% and not greater than 60% or at least 10% and not greater than 45%.

In an embodiment, the sbs polymer can have a particular styrene content that may facilitate improved performance and/or manufacturing of the asphalt blends and/or mixes. In an embodiment, the sbs polymer can have a styrene content of at least 10% or at least 12% or at least 14% or at least 16% or at least 18% or at least 20% or at least 22% or at least 24% or at least 26% or at least 28% or at least 30% or at least 32% or at least 34% or at least 36% or at least 38% or at least 40%. In an embodiment, the sbs polymer can have a styrene content of not greater than 50% or not greater than 48% or not greater than 46% or not greater than 44% or not greater than 42% or not greater than 40% or not greater than 38% or not greater than 36% or not greater than 34% or not greater than 32% or not greater than 30%. It will be appreciated that the styrene content of the sbs polymer may be between any of the minimum and maximum values noted above, including for example, but not limited to, at least 24% and not greater than 50% or at least 10% and not greater than 44%.

In an embodiment, the sbs polymer can have a particular molecular weight that may facilitate improved performance and/or manufacturing of the asphalt blends and/or mixes. In an embodiment, the sbs polymer can have a molecular weight of at least 180,000 or at least 190,000 or at least 200,000 or at least 210,000 or at least 220,000 or at least 230,000 or at least 240,000 or at least 250,000. In an embodiment, the sbs polymer can have a molecular weight of no greater than 320,000 or no greater than 310,000 or no greater than 300,000 or no greater than 290,000. It will be appreciated that the molecular weight of the sbs polymer may be between any of the minimum and maximum values noted above, including at least 180,000 and no greater than 320,000 or at least 250,000 and not greater than 300,000.

In an embodiment, the asphalt blend can further include a second polymer additive. The second polymer additive may have a particular composition that may facilitate improved performance and/or manufacturing of the asphalt blends and/or mixes. In an embodiment, the second polymer additive can be a di-block styrene butadiene polymer. In an embodiment the second polymer additive can be a linear sbs polymer, a radial sbs polymer, or a combination thereof.

In an embodiment, the second polymer additive can have a vinyl content that may facilitate improved performance and/or manufacturing of the asphalt blends and/or mixes. In an embodiment, the second polymer additive can have a vinyl content of at least 5% or at least 6% or at least 7% or at least 8% or at least 9% or at least 10% or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40%. In an embodiment, the second polymer additive can have a vinyl content of not greater than 75% or not greater than 60% or not greater than 50% or not greater than 45% or not greater than 40% or not greater than 38% or not greater than 36% or not greater than 34% or not greater than 32% or not greater than 30% or not greater than 28% or not greater than 26% or not greater than 24% or not greater than 20% or not greater than 18% or not greater than 26% or not greater than 24% or not greater than 12% or not greater than 10%. It will be appreciated that the vinyl content of the second polymer additive may be between any of the minimum and maximum values noted above, including for example, but not limited to, at least 25% and not greater than 60% or at least 10% and not greater than 45%.

In an embodiment, the second polymer additive can have a particular styrene content that may facilitate improved performance and/or manufacturing of the asphalt blends and/or mixes. In an embodiment, the second polymer additive can have a styrene content of at least 1% or at least 2% or at least 3% or at least 4% or at least 5% or at least 6% or at least 7% or at least 8% or at least 9% or at least 10% or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40%. In an embodiment, the second polymer additive can have a styrene content of not greater than 50% or not greater than 48% or not greater than 46% or not greater than 44% or not greater than 42% or not greater than 40% or not greater than 38% or not greater than 36% or not greater than 34% or not greater than 32% or not greater than 30%. It will be appreciated that the styrene content of the second polymer additive may be between any of the minimum and maximum values noted above, including for example, but not limited to, at least 24% and not greater than 50% or at least 10% and not greater than 44%.

In an embodiment, the second polymer additive can have a particular molecular weight that may facilitate improved performance and/or manufacturing of the asphalt blends and/or mixes. In an embodiment, the second polymer additive can have a molecular weight of at least 60,000 or at least 70,000 or at least 80,000 or at least 90,000 or at least 100,000 or at least 110,000 or at least 120,000 or at least 130,000 or at least 140,000 or at least 150,000 or at least 160,000 or at least 170,000 or at least 180,000 or at least 190,000 or at least 200,000 or at least 210,000 or at least 220,000 or at least 230,000 or at least 240,000 or at least 250,000. In an embodiment, the sbs polymer can have a molecular weight of no greater than 350,000 or no greater than 340,000 or no greater than 330,000 or no greater than 320,000 or no greater than 310,000 or no greater than 300,000 or no greater than 290,000. It will be appreciated that the molecular weight of the second polymer additive may be between any of the minimum and maximum values noted above, including at least 180,000 and no greater than 320,000 or at least 250,000 and no greater than 300,000.

In an embodiment, the asphalt blend may have a particular total polymer additive content that may provide improved performance and/or manufacturing of the asphalt blends and/or mixes. In an embodiment, the blend can have a total polymer additive content of at least 1 wt. % polymer additive content for a total weight of the blend or at least 1.5 wt. % polymer additive or at least 2 wt. % polymer additive or at least 2.5 wt. % polymer additive or at least 3 wt. % polymer additive or at least 3.5 wt. % polymer additive or at least 4 wt. % polymer additive or at least 4.5 wt. % polymer additive or at least 5 wt. % polymer additive or at least 5.5 wt. % polymer additive or at least 6 wt. % polymer additive for a total weight of the blend. In an embodiment, the blend can have a total polymer additive content of not greater than 10 wt. % polymer additive for a total weight of the blend or not greater than 9 wt. % polymer additive or not greater than 8 wt. % polymer additive or not greater than 7 wt. % polymer additive or not greater than 6 wt. % polymer additive or not greater than 5 wt. % polymer additive for a total weight of the blend. It will be appreciated that the total polymer additive content may be between any of the minimum and maximum values noted above, including for example, but not limited to, at least 2.5 wt. % and not greater than 10 wt. % or at least 4.5 wt. % and not greater than 8 wt. %.

In an embodiment, the asphalt blend may have a particular first polymer additive content that may provide improved performance and/or manufacturing of the asphalt blends and/or mixes. In an embodiment, the blend can have a first polymer additive content of at least 1 wt. % first polymer additive content for a total weight of the blend or at least 1.5 wt. % first polymer additive or at least 2 wt. % first polymer additive or at least 2.5 wt. % first polymer additive or at least 3 wt. % first polymer additive or at least 3.5 wt. % first polymer additive or at least 4 wt. % first polymer additive or at least 4.5 wt. % first polymer additive or at least 5 wt. % first polymer additive or at least 5.5 wt. % first polymer additive or at least 6 wt. % first polymer additive for a total weight of the blend. In an embodiment, the blend can have a first polymer additive content of not greater than 10 wt. % first polymer additive for a total weight of the blend or not greater than 9 wt. % first polymer additive or not greater than 8 wt. % first polymer additive or not greater than 7 wt. % first polymer additive or not greater than 6 wt. % first polymer additive or not greater than 5 wt. % first polymer additive for a total weight of the blend. It will be appreciated that the first polymer additive content may be between any of the minimum and maximum values noted above, including for example, but not limited to, at least 2.5 wt. % and not greater than 10 wt. % or at least 4.5 wt. % and not greater than 8 wt. %.

In an embodiment, the asphalt blend may have a particular second polymer additive content that may provide improved performance and/or manufacturing of the asphalt blends and/or mixes. In an embodiment, the blend can have a second polymer additive content of at least 1 wt. % second polymer additive content for a total weight of the blend or at least 1.5 wt. % second polymer additive or at least 2 wt. % second polymer additive or at least 2.5 wt. % second polymer additive or at least 3 wt. % second polymer additive or at least 3.5 wt. % second polymer additive or at least 4 wt. % second polymer additive or at least 4.5 wt. % second polymer additive or at least 5 wt. % second polymer additive or at least 5.5 wt. % second polymer additive or at least 6 wt. % second polymer additive for a total weight of the blend. In an embodiment, the blend can have a second polymer additive content of not greater than 10 wt. % second polymer additive for a total weight of the blend or not greater than 9 wt. % second polymer additive or not greater than 8 wt. % second polymer additive or not greater than 7 wt. % second polymer additive or not greater than 6 wt. % second polymer additive or not greater than 5 wt. % second polymer additive for a total weight of the blend. It will be appreciated that the second polymer additive content may be between any of the minimum and maximum values noted above, including for example, but not limited to, at least 2.5 wt. % and not greater than 10 wt. % or at least 4.5 wt. % and not greater than 8 wt. %.

In an embodiment, the asphalt blend may also include a wax. The wax may have a particular composition that may facilitate improved performance and/or manufacturing of the filled asphalt mix. In an embodiment, the wax can include a paraffin wax, an alpha olefin wax, a polyamide wax, an ethylene vinyl acetate (EVA) wax, a polypropylene wax, a polyethylene wax or a combination thereof. In an embodiment, the wax may include a polypropylene wax. In an embodiment, the wax may include a polyethylene wax. In an embodiment, the wax may include a polypropylene and polyethylene wax. In an embodiment, the wax can be a recycled wax. The wax may be processed from a feed including recycled or virgin plastics.

In an embodiment, the asphalt blend may have a particular wax content that may provide improved performance and/or manufacturing of the asphalt blends and/or mixes. In an embodiment, the blend can have a wax content of at least 0.5 wt. % wax for a total weight of the blend or at least 1 wt. % or at least 1.5 wt. % or at least 2 wt. %. In an embodiment, the blend can have a wax content of not greater than 10 wt. % or not greater than 5 wt. % or not greater than 4 wt. % or not greater than 3 wt. % or not greater than 2 wt. %. It will be appreciated that the wax content may be between any of the minimum and maximum values noted above, including for example, but not limited to, at least 0.5 wt. % and not greater than 5 wt. % or at least 1 wt. % and not greater than 4 wt. %.

The process can continue with step 103, mixing the intermediate asphalt blend with ground tire rubber to provide an asphalt blend.

In an embodiment, mixing the asphalt blend may be done with low shear mixing. The low shear mixing may be done with a paddle blade mixer. Low shear mixing may include mixing with a shear rate of not greater than 10,000 s⁻¹.

In an embodiment, the paddle blade mixer may be operated with a particular speed that may facilitate improved performance and/or manufacturing of the asphalt blends or mixes. In an embodiment, the paddle blade mixer may be operated with a speed of at least 400 rpm or at least 450 rpm or at least 500 rpm or at least 550 rpm or at least 600 rpm or at least 650 rpm or at least 700 rpm. In an embodiment, a paddle blade mixer may be operated with a speed of no greater than 1600 rpm or no greater than 1500 rpm or no greater than 1400 rpm or no greater than 1300 rpm or no greater than 1200 rpm or no greater than 1100 rpm or no greater than 1000 rpm or no greater than 900 rpm or no greater than 800 rpm. It will be appreciated that the paddle blade mixer may be operated with a speed between any of the minimum and maximum values noted above, including for example, but not limited to, at least 700 rpm and no greater than 800 rpm or at least 400 rpm and no greater than 1400 rpm.

In an embodiment, mixing the asphalt blend may be done at a particular temperature that may facilitate improved performance and/or manufacturing of the asphalt mix. In an embodiment, the mixing may be done at a temperature of at least 350° F. or at least 360° F. or at least 370° F. or at least 380° F. or at least 390° F. In an embodiment, mixing may be done at a temperature of no greater than 450° F. or no greater than 440° F. or no greater than 430° F. or no greater than 420° F. or no greater than 410° F. It will be appreciated that the mixing temperature may be between any of the minimum and maximum values noted above, including for example, but not limited to, at least 350° F. and not greater than 440° F. or at least 370° F. and not greater than 430° F.

In an embodiment, the blend may have a particular ground tire rubber content that may provide improved performance and/or manufacturing of the asphalt blends and/or mixes. In an embodiment the blend can have a ground tire rubber content of at least 2.0 wt. % ground tire rubber for a total weight of the blend or at least 2.1 wt. % ground tire rubber or at least 2.2 wt. % ground tire rubber or at least 2.3 wt. % ground tire rubber or at least 2.4 wt. % ground tire rubber or at least 2.5 wt. % ground tire rubber or at least 2.6 wt. % ground tire rubber or at least 2.7 wt. % ground tire rubber or at least 2.8 wt. % ground tire rubber or at least 2.9 wt. % ground tire rubber or at least 3.0 wt. % ground tire rubber or at least 3.1 wt. % ground tire rubber or at least 3.2 wt. % ground tire rubber or at least 3.3 wt. % ground tire rubber or at least 3.4 wt. % ground tire rubber or at least 3.5 wt. % ground tire rubber or at least 3.6 wt. % ground tire rubber or at least 3.7 wt. % ground tire rubber or at least 3.8 wt. % ground tire rubber or at least 3.9 wt. % ground tire rubber or at least 4.0 wt. % ground tire rubber or at least 4.1 wt. % ground tire rubber or at least 4.2 wt. % ground tire rubber or at least 4.3 wt. % ground tire rubber or at least 4.4 wt. % ground tire rubber or at least 4.5 or at least 4.6 wt. % ground tire rubber or at least 4.7 wt. % ground tire rubber or at least 4.8 wt. % ground tire rubber or at least 4.9 wt. % ground tire rubber or at least 5.0 wt. % ground tire rubber or at least 5.1 wt. % ground tire rubber or at least 5.2 wt. % ground tire rubber or at least 5.3 wt. % ground tire rubber or at least 5.4 wt. % ground tire rubber or at least 5.5 wt. % ground tire rubber. In an embodiment, the blend can have a ground tire rubber content of not greater than 25 wt. % ground tire rubber for a total weight of the blend or not greater than 24 wt. % ground tire rubber or not greater than 23 wt. % ground tire rubber or not greater than 22 wt. % ground tire rubber or not greater than 21 wt. % ground tire rubber or not greater than 20 wt. % ground tire rubber or not greater than 19 wt. % ground tire rubber or not greater than 18 wt. % ground tire rubber or not greater than 17 wt. % ground tire rubber or not greater than 16 wt. % ground tire rubber or not greater than 15 wt. % ground tire rubber or not greater than 14 wt. % ground tire rubber or not greater than 13 wt. % ground tire rubber or not greater than 12 wt. % ground tire rubber or not greater than 11 wt. % ground tire rubber or not greater than 10 wt. % ground tire rubber or not greater than 9 wt. % ground tire rubber or not greater than 8 wt. % ground tire rubber. It will be appreciated that the ground tire rubber content may be between any of the minimum and maximum values noted above, including for example, but not limited to, at least 2.5 wt. % and not greater than 10 wt. % or at least 4.5 wt. % and not greater than 8 wt. %.

In an embodiment, the ground tire rubber may have a particular particle size that may facilitate improved performance and/or manufacturing of the asphalt blends and mixes. In an embodiment, the ground tire rubber may have a mesh size of greater than 80 or at least 90 or at least 100 or at least 110 or at least 120 or at least 130 or at least 140. In an embodiment, the ground tire rubber may have a mesh size of no greater than 500 or no greater than 450 or no greater than 400 or no greater than 325 or no greater than 270 or no greater than 230 or no greater than 200 or no greater than 170 or no greater than 140. It will be appreciated that the ground tire rubber size may be between any of the minimum and maximum values noted above, including for example but not limited to, greater than 80 and no greater than 400 or at least 100 and no greater than 325.

In an embodiment, the asphalt blend may have a particular softening point that may provide improved performance and/or manufacturing of the asphalt blends and/or mixes. In an embodiment, the softening point may be no greater than 300° F. or not greater than 290° F. or not greater than 280° F. or not greater than 270° F. or not greater than 260° F. or not greater than 250 OF or not greater than 240° F. or not greater than 230° F. or not greater than 220° F. In an embodiment, the softening point may be at least 200° F. or at least 201° F. or at least 202° F. or at least 203° F. or at least 204° F. or at least 205° F. or at least 206° F. or at least 207° F. or at least 208° F. or at least 209° F. or at least 210° F. or at least 211° F. or at least 212° F. or at least 213° F. or at least 214° F. or at least 215° F. It will be appreciated that the softening point may be between any of the minimum and maximum values noted above, including for example, but not limited to, at least 212° F. and not greater than 300° F. or at least 207° F. and not greater than 290° F.

In an embodiment, the asphalt blend may have a particular softening point differential that may provide improved performance and/or manufacturing of the asphalt blends and/or mixes. The softening point differential may be measured according to the process of Example 2 of this specification. In an embodiment, the softening point differential may be no greater than 6 OF or no greater than 5.5° F. or no greater than 5° F. or no greater than 4.5° F. or no greater than 4 OF or no greater than 3.5° F. or no greater than 3° F. In an embodiment, the softening point differential may be at least 0.01° F. or at least 0.1° F. or at least 1° F. It will be appreciated that the softening point differential may be between any of the minimum and maximum values noted above, including for example, but not limited to, at least 0.01° F. and not greater than 5° F. or at least 1° F. and not greater than 3° F.

In an embodiment, the asphalt blend may have a particular penetration at 32° F. that may provide improved performance and/or manufacturing of the asphalt blends and or mixes. In an embodiment, the penetration at 32° F. may be no greater than 20 dmm or no greater than 18 dmm or no greater than 16 dmm or no greater than 14 dmm or no greater than 13 dmm or no greater than 12 dmm. In an embodiment, the penetration at 32° F. may be at least 5 dmm or at least 6 dmm or at least 7 dmm or at least 8 dmm or at least 9 dmm or at least 10 dmm or at least 11 dmm or at least 12 dmm. It will be appreciated that the penetration at 32° F. may be between any of the minimum and maximum values noted above, including for example, but not limited to, at least 5 dmm and no greater than 16 dmm or at least 6 dmm and no greater than 16 dmm.

In an embodiment, the asphalt blend may have a particular penetration at 77° F. that may provide improved performance and/or manufacturing of the asphalt blends and or mixes. In an embodiment, the penetration at 77° F. may be no greater than 40 dmm or no greater than 39 dmm or no greater than 38 dmm or no greater than 37 dmm or no greater than 36 dmm or no greater than 35 dmm or no greater than 34 dmm or no greater than 33 dmm or no greater than 32. In an embodiment, the penetration at 77° F. may be at least 21 dmm or at least 22 dmm or at least 23 dmm or at least 24 dmm or at least 25 dmm or at least 26 dmm or at least 27 dmm or at least 28 dmm or at least 29 dmm or at least 30 dmm or at least 31 dmm or at least 32 dmm. It will be appreciated that the penetration at 77° F. may be between any of the minimum and maximum values noted above, including for example, but not limited to, at least 31 dmm and no greater than 36 dmm or at least 29 dmm and no greater than 35 dmm.

In an embodiment, the asphalt blend may have a particular penetration at 115° F. that may provide improved performance and/or manufacturing of the asphalt blends and or mixes. In an embodiment, the penetration at 115° F. may be no greater than 92 dmm or no greater than 91 dmm or no greater than 90 dmm or no greater than 89 dmm or no greater than 88 dmm or no greater than 87 dmm or no greater than 86 dmm or no greater than 85 dmm or no greater than 84 dmm. In an embodiment, the penetration at 115° F. may be at least 71 dmm or at least 72 dmm or at least 73 dmm or at least 74 dmm or at least 75 dmm or at least 76 dmm or at least 77 dmm or at least 78 dmm or at least 79 dmm or at least 80 dmm or at least 81 dmm or at least 82 dmm or at least 83 dmm or at least 84 dmm. It will be appreciated that the penetration at 115° F. may be between any of the minimum and maximum values noted above, including for example, but not limited to, at least 71 dmm and no greater than 90 dmm or at least 80 dmm and no greater than 85 dmm.

In an embodiment, the asphalt blend may have a particular viscosity at 400° F. that may provide improved performance and/or manufacturing of the asphalt blends and/or mixes. In an embodiment, the viscosity may be at least 360 cps or at least 370 cps or at least 380 cps or at least 390 cps or at least 400 cps or at least 410 cps or at least 420 cps. In an embodiment, the viscosity may be no greater than 800 cps or no greater than 750 cps or no greater than 700 cps or no greater than 650 cps or no greater than 600 cps or no greater than 550 cps or no greater than 500 cps or no greater than 450 cps. It will be appreciated that the viscosity may be between any of the minimum and maximum values noted above, including for example, but not limited to, at least 360 cps and not greater than 800 cps or at least 420 cps and not greater than 550 cps.

The process can continue with step 104, mixing the asphalt blend with a filler to provide a filled asphalt mix.

In an embodiment, mixing the filled asphalt mix may be done at a particular temperature that may facilitate improved performance and/or manufacturing of the asphalt mix. In an embodiment, the mixing may be done at a temperature of at least 350° F. or at least 360° F. or at least 370° F. or at least 380° F. or at least 390° F. In an embodiment, mixing may be done at a temperature of no greater than 450° F. or no greater than 440° F. or no greater than 430° F. or no greater than 420° F. or no greater than 410° F. It will be appreciated that the mixing temperature may be between any of the minimum and maximum values noted above, including for example, but not limited to, at least 350° F. and not greater than 440° F. or at least 370° F. and not greater than 430° F.

In an embodiment, the filler may have a particular composition that may facilitate improved performance and/or manufacturing of the filled asphalt mix. In an embodiment, the filler can be limestone. In an embodiment, the filler can be CaCO₃.

In an embodiment, the filled asphalt mix may have a particular filler content that may provide improved performance and/or manufacturing of the asphalt mix. In an embodiment, the mix can have a filler content of at least 40 wt. % filler for a total weight of the mix or at least 42 wt. % or at least 44 wt. % or at least 46 wt. % or at least 48 wt. % or at least 50 wt. % or at least 52 wt. % or at least 54 wt. % or at least 56 wt. % or at least 58 wt. % or at least 60 wt. % or at least 62 wt. % or at least 64 wt. % or at least 66 wt. % or at least 68 wt. % or at least 70 wt. % or at least 72 wt. % or at least 74 wt. % or at least 76 wt. % or at least 78 wt. % or at least 80 wt. %. In an embodiment, the mix can have a filler content of not greater than 90 wt. % filler for a total weight of the mix or not greater than 88 wt. % or not greater than 86 wt. % or not greater than 84 wt. % or not greater than 82 wt. % or not greater than 80 wt. % or not greater than 78 wt. % or not greater than 76 wt. % or not greater than 74 wt. % or not greater than 72 wt. % or not greater than 70 wt. %. It will be appreciated that the filler content may be between any of the minimum and maximum values noted above, including for example, but not limited to, at least 40 wt. % and not greater than 90 wt. % or at least 60 wt. % and not greater than 80 wt. %.

In an embodiment, the filled asphalt mix may have a particular softening point that may provide improved performance and/or manufacturing of the asphalt mix. In an embodiment, the softening point may be not greater than 325° F. or not greater than 320° F. or not greater than 315 OF or not greater than 310° F. or not greater than 305° F. or not greater than 300° F. or not greater than 295° F. or not greater than 290° F. or not greater than 285° F. or not greater than 280° F. or not greater than 275° F. or not greater than 270° F. In an embodiment, the softening point may be at least 250° F. or at least 251° F. or at least 252° F. or at least 253° F. or at least 254° F. or at least 255° F. or at least 256° F. or at least 257° F. or at least 258° F. or at least 259° F. or at least 260° F. or at least 261° F. or at least 262° F. or at least 263° F. or at least 264° F. or at least 265° F. or at least 266° F. or at least 267° F. or at least 268° F. It will be appreciated that the softening point may be between any of the minimum and maximum values noted above, including for example, but not limited to, at least 250° F. and not greater than 325° F. or at least 264° F. and not greater than 310° F.

In an embodiment, the filled asphalt mix may have a particular penetration at 32° F. that may provide improved performance and/or manufacturing of the asphalt mix. In an embodiment, the penetration at 32° F. may be no greater than 10 dmm or no greater than 9 dmm or no greater than 8 dmm or no greater than 7 dmm or no greater than 6 dmm or no greater than 5 dmm or no greater than 4 dmm. In an embodiment, the penetration at 32° F. may be at least 1 dmm or at least 2 dmm or at least 3 dmm or at least 4 dmm or at least 5 dmm or at least 6 dmm or at least 7 dmm. It will be appreciated that the penetration at 32° F. may be between any of the minimum and maximum values noted above, including for example, but not limited to, at least 1 dmm and no greater than 10 dmm or at least 2 dmm and no greater than 8 dmm.

In an embodiment, the filled asphalt mix may have a particular penetration at 77° F. that may provide improved performance and/or manufacturing of the asphalt mix. In an embodiment, the penetration at 77° F. may be no greater than 20 dmm or no greater than 19 dmm or no greater than 18 dmm or no greater than 17 dmm or no greater than 16 dmm or no greater than 15 dmm or no greater than 14 dmm or no greater than 13 dmm or no greater than 12 dmm. In an embodiment, the penetration at 77° F. may be at least 1 dmm or at least 2 dmm or at least 3 dmm or at least 4 dmm or at least 5 dmm or at least 6 dmm or at least 7 dmm or at least 8 dmm or at least 9 dmm or at least 10 dmm or at least 11 dmm or at least 12 dmm or at least 13 dmm. It will be appreciated that the penetration at 77° F. may be between any of the minimum and maximum values noted above, including for example, but not limited to, at least 1 dmm and no greater than 20 dmm or at least 9 dmm and no greater than 13 dmm.

In an embodiment, the filled asphalt mix may have a particular penetration at 115° F. that may provide improved performance and/or manufacturing of the asphalt mix. In an embodiment, the penetration at 115° F. may be no greater than 40 dmm or no greater than 39 dmm or no greater than 38 dmm or no greater than 37 dmm or no greater than 36 dmm or no greater than 35 dmm or no greater than 34 dmm or no greater than 33 dmm or no greater than 32 dmm or no greater than 31 dmm or no greater than 30 dmm. In an embodiment, the penetration at 115° F. may be at least 21 dmm or at least 22 dmm or at least 23 dmm or at least 24 dmm or at least 25 dmm or at least 26 dmm or at least 27 dmm or at least 28 dmm or at least 29 dmm or at least 30 dmm. It will be appreciated that the penetration at 115° F. may be between any of the minimum and maximum values noted above, including for example, but not limited to, at least 21 dmm and no greater than 40 dmm or at least 30 dmm and no greater than 33 dmm.

In an embodiment, the filled asphalt mix may have a particular viscosity at 400° F. that may provide improved performance and/or manufacturing of the asphalt mix. In an embodiment, the viscosity may be at least 3600 cps or at least 3700 cps or at least 3800 cps or at least 3900 cps or at least 4000 cps or at least 4100 cps or at least 4200 cps or at least 4300 cps or at least 4400 cps or at least 4500 cps or at least 4600 cps or at least 4700 cps or at least 4800 cps or at least 4900 cps or at least 5000 cps or at least 5100 cps or at least 5200 cps or at least 5300 cps. In an embodiment, the viscosity may be no greater than 8000 cps or no greater than 7500 cps or no greater than 7000 cps or no greater than 6500 cps or no greater than 6000 cps or no greater than 5500 cps or no greater than 5000 cps or no greater than 4500 cps. It will be appreciated that the viscosity may be between any of the minimum and maximum values noted above, including for example, but not limited to, at least 3800 cps and not greater than 8000 cps or at least 4300 cps and not greater than 6000 cps.

In an embodiment, the filled asphalt mix may have a non-adhesion factor that may provide improved performance and/or manufacturing of the asphalt mix. Non-adhesion factor (NAF) may be measured according to the process outlined in the examples. In an embodiment, the NAF may be not greater than 3.0 PLI o or not greater than 2.90 PLI or not greater than 2.80 PLI or not greater than 2.70 PLI or not greater than 2.60 PLI or not greater than 2.50 PLI or not greater than 2.40 PLI or not greater than 2.30 PLI or not greater than 2.20 PLI or not greater than 2.10 PLI or not greater than 2.00 PLI or not greater than 1.90 PLI or not greater than 1.80 PLI or not greater than 1.70 PLI. In an embodiment, the NAF may be at least 0.50 PLI or at least 1.00 PLI or at least 1.50 PLI. It will be appreciated that the NAF may be between any of the minimum and maximum values noted above, including for example, but not limited to, at least 1.00 PLI and not greater than 3.0 PLI or at least 1.50 PLI and not greater than 2.50 PLI.

In an embodiment, a shingle can include a substrate coated with any of the asphalt blends or mixes described herein.

In an embodiment, the shingles may be packaged in bundles. In an embodiment, the bundles may include at least 10 shingles or at least 11 shingles or at least 12 shingles or at least 13 shingles or at least 14 shingles or at least 15 shingles or at least 16 shingles or at least 17 shingles or at least 18 shingles or at least 19 shingles or at least 20 shingles. In an embodiment, the bundles may include no greater than 30 shingles or no greater than 28 shingles or no greater than 26 shingles or no greater than 24 shingles or no greater than 22 shingles.

In an embodiment, a pallet can include a palleted plurality of roofing shingles comprising a plurality of roofing shingles disposed in one or more stacks on a pallet, wherein the pallet has a top surface formed of a plurality of top boards, and wherein:
(a) adjacent boards of the plurality of top boards have a gap of no more than one inch therebetween at the top surfaces thereof; and/or
(b) the plurality of top boards take up at least 85% of the occluded area of the top surface of the pallet;
(c) each of the plurality of top boards has a thickness of at least 0.55 inches.

The palleted shingles can include shingles including asphalt blends or mixes according to the embodiments herein. In an embodiment, a pallet can include 3-5 stacks. In an embodiment, a pallet can include 4 stacks.

The shingles can be packaged in one or more bundles making up each stack, the bundles as described above. As the person of ordinary skill in the art will appreciate, each bundle can include any desired number of shingles, e.g., in the range of 16-30, for example, 20 shingles per bundle or 22 shingles per bundle. Shingles can be packaged face-to-face in pairs. Shingles can also be stacked face to back. Bundles can be stacked on a pallet in any desirable manner. For example, a pallet can include 3-5 stacks of bundles, or 4 stacks of bundles.

A pallet can have bundles of shingles stacked, at least 6 bundles high or at least 7 bundles high or at least 8 bundles high or at least 9 bundles high or at least 10 bundles high or at least 11 bundles high or at least 12 bundles high. The stacks may also include no greater than 16 bundles or no greater than 15 bundles or no greater than 14 bundles or no greater than 13 bundles or no greater than 12 bundles.

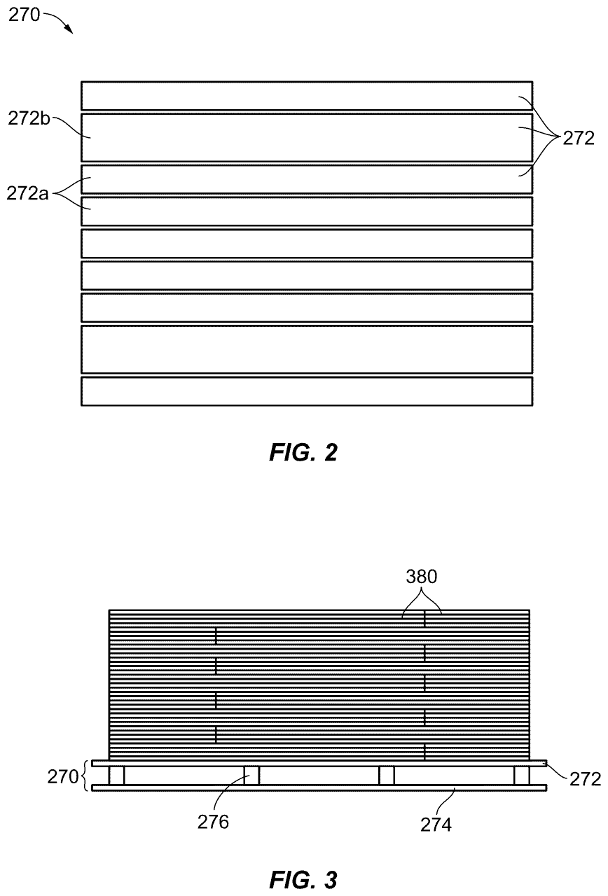

An example of a pallet is shown in schematic top view in FIG. 2, and in schematic side view (with shingles stacked thereon) in FIG. 3. Pallet 270 includes a plurality of top boards 272 and a plurality of bottom boards 274, affixed (e.g., via nails or screws) to opposite sides of a series of stringers 276. Notably, the top boards need not be uniform; for example, in the embodiment of FIGS. 2 and 3, there are two types of top boards with different widths, 272 a (narrower) and 272 b (wider). In FIG. 3, bundles 380 are stacked on the pallet. Each bundle has, e.g., 20 or 22 roofing shingles. And there are nine courses of bundles stacked on the pallet; each course has three bundles extending parallel to the plane of the page and one bundle extending perpendicular to the plane of the page, as is conventional.

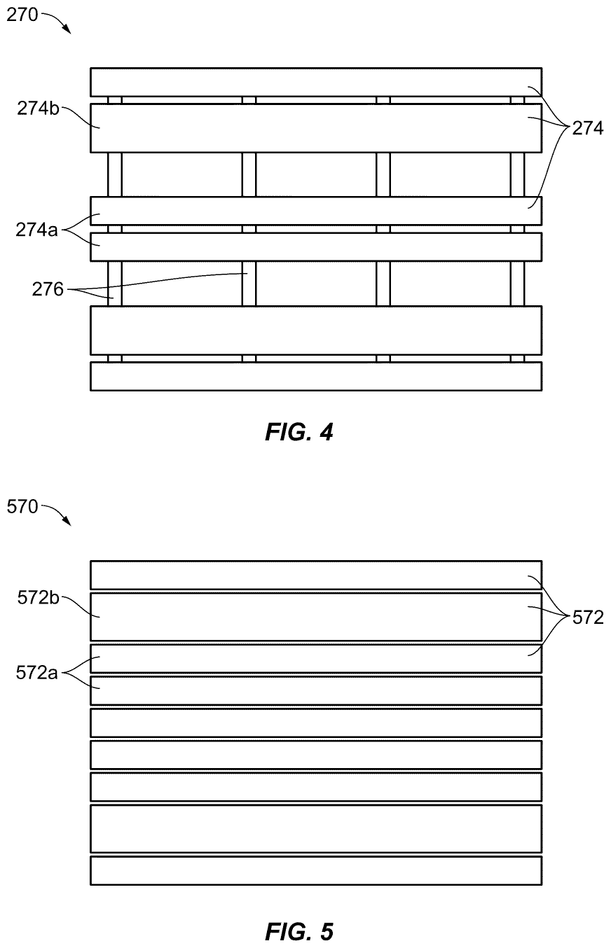

FIGS. 4 and 5 exhibit two examples of arrangements of the plurality of bottom boards of pallets of the disclosure. FIG. 4 is a schematic bottom view of the pallet of FIG. 2. Pallet 270 includes a plurality of bottom boards 274 affixed (e.g., via nails or screws) to bottom sides of stringers 276. Like the top boards, the bottom boards need not be uniform; for example, in the embodiment of FIG. 4, there are two types of bottom boards with different widths, 274a (narrower) and 274b (wider). Notably, in this embodiment, as is common for pallets, the bottom boards do not substantially fill the area at the bottom of the pallet.

FIG. 5 is a schematic bottom view of another pallet 570 useful in various embodiments of the disclosure. In this embodiment, the structure of the top boards and the stringers is as described above with respect to FIGS. 2 and 3. Here, the bottom boards substantially fill the area at the bottom of the pallet. As shown, the pallet includes boards 572 with different widths, 572 a (narrower) and 572 b (wider).

### EMBODIMENTS

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. An asphalt blend comprising:
asphalt,
a first polymer additive,
ground tire rubber having a mesh size greater than 80 mesh.

Embodiment 2. The blend of embodiment 1, wherein the asphalt comprises paving grade asphalt.

Embodiment 3. The blend of embodiment 2, wherein the paving grade asphalt comprises a high temperature performance grade of at least 46° C. or at least 52° C. or at least 58° C. or at least 64° C. or at least 70° C. or at least 82° C.

Embodiment 4. The blend of embodiment 2, wherein the paving grade asphalt comprises a high temperature performance grade of not greater than 82° C. or not greater than 76° C. or not greater than 70° C. or not greater than 64° C. or not greater than 58° C. or not greater than 52° C. or not greater than 46° C.

Embodiment 5. The blend of embodiment 2, wherein the paving grade asphalt comprises a low temperature performance grade of at least −46° C. or at least 40° C. or at least −34° C. or at least −28° C. or at least −22° C. or at least −20° C. or at least −18° C. or at least −16° C. or at least −14° C. or at least −12° C.

Embodiment 6. The blend of embodiment 2, wherein the paving grade asphalt comprises a low temperature performance grade of not greater than −10° C. or not greater than −16° C. or not greater than −22° C. or not greater than −28° C. or not greater than −34° C. or not greater than −40° or not greater than −46° C.

Embodiment 7. The blend of embodiment 2, wherein the paving grade asphalt comprises PG 64-22 asphalt.

Embodiment 8. The blend of embodiment 1, wherein the asphalt blend comprises an asphalt content of at least 70 wt. % for a total weight of the blend or at least 72 wt. % or at least 74 wt. % or at least 76 wt. % or at least 78 wt. % or at least 80 wt. % or at least 82 wt. % or at least 84 wt. % or at least 86 wt. % or at least 88 wt. % or at least 90 wt. % or at least 92 wt. % or at least 94 wt. %.

Embodiment 9. The blend of embodiment 1, wherein the asphalt blend comprises an asphalt content of no greater than 99 wt. % for a total weight of the blend or no greater than 98 wt. % or no greater than 96 wt. % or no greater than 94 wt. % or no greater than 92 wt. % or no greater than 90 wt. % or no greater than 88 wt. % or no greater than 86 wt. % or no greater than 84 wt. % or no greater than 82 wt. % or no greater than 80 wt. %.

Embodiment 10. The blend of embodiment 1, wherein the asphalt blend comprises at least 2.0 wt. % ground tire rubber for a total weight of the blend or at least 2.1 wt. % ground tire rubber or at least 2.2 wt. % ground tire rubber or at least 2.3 wt. % ground tire rubber or at least 2.4 wt. % ground tire rubber or at least 2.5 wt. % ground tire rubber or at least 2.6 wt. % ground tire rubber or at least 2.7 wt. % ground tire rubber or at least 2.8 wt. % ground tire rubber or at least 2.9 wt. % ground tire rubber or at least 3.0 wt. % ground tire rubber or at least 3.1 wt. % ground tire rubber or at least 3.2 wt. % ground tire rubber or at least 3.3 wt. % ground tire rubber or at least 3.4 wt. % ground tire rubber or at least 3.5 wt. % ground tire rubber or at least 3.6 wt. % ground tire rubber or at least 3.7 wt. % ground tire rubber or at least 3.8 wt. % ground tire rubber or at least 3.9 wt. % ground tire rubber or at least 4.0 wt. % ground tire rubber or at least 4.1 wt. % ground tire rubber or at least 4.2 wt. % ground tire rubber or at least 4.3 wt. % ground tire rubber or at least 4.4 wt. % ground tire rubber or at least 4.5 or at least 4.6 wt. % ground tire rubber or at least 4.7 wt. % ground tire rubber or at least 4.8 wt. % ground tire rubber or at least 4.9 wt. % ground tire rubber or at least 5.0 wt. % ground tire rubber or at least 5.1 wt. % ground tire rubber or at least 5.2 wt. % ground tire rubber or at least 5.3 wt. % ground tire rubber or at least 5.4 wt. % ground tire rubber or at least 5.5 wt. % ground tire rubber.

Embodiment 11. The blend of embodiment 1, wherein the asphalt blend comprises a ground tire rubber content not greater than 25 wt. % ground tire rubber for a total weight of the blend or not greater than 24 wt. % ground tire rubber or not greater than 23 wt. % ground tire rubber or not greater than 22 wt. % ground tire rubber or not greater than 21 wt. % ground tire rubber or not greater than 20 wt. % ground tire rubber or not greater than 19 wt. % ground tire rubber or not greater than 18 wt. % ground tire rubber or not greater than 17 wt. % ground tire rubber or not greater than 16 wt. % ground tire rubber or not greater than 15 wt. % ground tire rubber or not greater than 14 wt. % ground tire rubber or not greater than 13 wt. % ground tire rubber or not greater than 12 wt. % ground tire rubber or not greater than 11 wt. % ground tire rubber or not greater than 10 wt. % ground tire rubber or not greater than 9 wt. % ground tire rubber or not greater than 8 wt. % ground tire rubber.

Embodiment 12. The blend of embodiment 1, wherein the tire rubber comprises a mesh size of at least 90 or at least 100 or at least 110 or at least 120 or at least 130 or at least 140.

Embodiment 13. The blend of embodiment 1, wherein the tire rubber comprises a mesh size of no greater than 500 or no greater than 450 or no greater than 400 or no greater than 325 or no greater than 270 or no greater than 230 or no greater than 200 or no greater than 170 or no greater than 140.

Embodiment 14. The blend of embodiment 1, wherein the first polymer additive is a styrene-butadiene-styrene (sbs) polymer.

Embodiment 15. The blend of embodiment 14, wherein the sbs polymer is a linear sbs polymer, a radial sbs polymer, or a combination thereof.

Embodiment 16. The blend of embodiment 14, wherein the sbs polymer is a linear sbs polymer.

Embodiment 17. The blend of embodiment 14, wherein the sbs polymer is a radial sbs polymer.

Embodiment 18. The blend of embodiment 14, wherein the sbs polymer comprises a polybutadiene mid-block vinyl content of at least 5% or at least 6% or at least 7% or at least 8% or at least 9% or at least 10% or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40%.

Embodiment 19. The blend of embodiment 14, wherein the sbs polymer comprises a polybutadiene mid-block vinyl content of not greater than 75% or not greater than 60% or not greater than 50% or not greater than 45%.

Embodiment 20. The blend of embodiment 14, wherein the sbs polymer comprises a styrene content of at least 10% or at least 12% or at least 14% or at least 16% or at least 18% or at least 20% or at least 22% or at least 24% or at least 26% or at least 28% or at least 30% or at least 32% or at least 34% or at least 36% or at least 38% or at least 40%.

Embodiment 21. The blend of embodiment 14, wherein the sbs polymer comprises a styrene content of not greater than 50% or not greater than 48% or not greater than 46% or not greater than 44% or not greater than 42% or not greater than 40% or not greater than 38% or not greater than 36% or not greater than 34% or not greater than 32% or not greater than 30%.

Embodiment 22. The blend of embodiment 14, wherein the sbs polymer comprises a molecular weight of at least 180,000 or at least 190,000 or at least 200,000 or at least 210,000 or at least 220,000 or at least 230,000 or at least 240,000 or at least 250,000.

Embodiment 23. The blend of embodiment 14, wherein the sbs polymer comprises a molecular weight of no greater than 320,000 or no greater than 310,000 or no greater than 300,000 or no greater than 290,000.

Embodiment 24. The blend of embodiment 1, wherein the composition comprises a second polymer additive.

Embodiment 25. The blend of embodiment 24, wherein the second polymer additive is a di-block styrene butadiene polymer.

Embodiment 26. The blend of embodiment 24, wherein the second polymer additive is a second sbs polymer.

Embodiment 27. The blend of embodiment 24, wherein the second polymer additive is a linear polymer, a radial polymer, or a combination thereof.

Embodiment 28. The blend of embodiment 24, wherein the second polymer additive is a linear polymer.

Embodiment 29. The blend of embodiment 24, wherein the second polymer additive is a radial polymer.

Embodiment 30. The blend of embodiment 24, wherein the second polymer additive comprises a vinyl content of at least 1% or at least 2% or at least 3% or at least 4% or at least 5% or at least 6% or at least 7% or at least 8% or at least 9% or at least 10% or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40%.

Embodiment 31. The blend of embodiment 24, wherein the second polymer additive comprises a vinyl content of not greater than 40% or not greater than 38% or not greater than 36% or not greater than 34% or not greater than 32% or not greater than 30% or not greater than 28% or not greater than 26% or not greater than 24% or not greater than 20% or not greater than 18% or not greater than 26% or not greater than 24% or not greater than 12% or not greater than 10%.

Embodiment 32. The blend of embodiment 24, wherein the second polymer additive comprises a styrene content of at least 1% or at least 2% or at least 3% or at least 4% or at least 5% or at least 6% or at least 7% or at least 8% or at least 9% or at least 10% or at least 11% or at least 12% or at least 13% or at least 14% or at least 15% or at least 16% or at least 17% or at least 18% or at least 19% or at least 20% or at least 21% or at least 22% or at least 23% or at least 24% or at least 25% or at least 26% or at least 27% or at least 28% or at least 29% or at least 30% or at least 31% or at least 32% or at least 33% or at least 34% or at least 35% or at least 36% or at least 37% or at least 38% or at least 39% or at least 40%.

Embodiment 33. The blend of embodiment 24, wherein the second polymer additive comprises a styrene content of not greater than 50% or not greater than 48% or not greater than 46% or not greater than 44% or not greater than 42% or not greater than 40% or not greater than 38% or not greater than 36% or not greater than 34% or not greater than 32% or not greater than 30%.

Embodiment 34. The blend of embodiment 24, wherein the second polymer additive comprises a molecular weight of at least 60,000 or at least 70,000 or at least 80,000 or at least 90,000 or at least 100,000 or at least 110,000 or at least 120,000 or at least 130,000 or at least 140,000 or at least 150,000 or at least 160,000 or at least 170,000 or at least 180,000 or at least 190,000 or at least 200,000 or at least 210,000 or at least 220,000 or at least 230,000 or at least 240,000 or at least 250,000.

Embodiment 35. The blend of embodiment 24, wherein the second polymer additive comprises a molecular weight of no greater than 350,000 or no greater than 340,000 or no greater than 330,000 or no greater than 320,000 or no greater than 310,000 or no greater than 300,000 or no greater than 290,000.

Embodiment 36. The blend of embodiment 24, wherein the asphalt blend comprises a polymer additive content of at least 1 wt. % polymer additive content for a total weight of the blend or at least 1.5 wt. % polymer additive or at least 2 wt. % polymer additive or at least 2.5 wt. % polymer additive or at least 3 wt. % polymer additive or at least 3.5 wt. % polymer additive or at least 4 wt. % polymer additive or at least 4.5 wt. % polymer additive or at least 5 wt. % polymer additive or at least 5.5 wt. % polymer additive or at least 6 wt. % polymer additive for a total weight of the blend.

Embodiment 37. The blend of embodiment 1, wherein the asphalt blend comprises a polymer additive content of not greater than 10 wt. % polymer additive for a total weight of the blend or not greater than 9 wt. % polymer additive or not greater than 8 wt. % polymer additive or not greater than 7 wt. % polymer additive or not greater than 6 wt. % polymer additive or not greater than 5 wt. % polymer additive for a total weight of the blend.

Embodiment 38. The blend of embodiment 1, wherein the asphalt blend comprises a first polymer additive content of at least 1 wt. % first polymer additive content for a total weight of the blend or at least 1.5 wt. % first polymer additive or at least 2 wt. % first polymer additive or at least 2.5 wt. % first polymer additive or at least 3 wt. % first polymer additive or at least 3.5 wt. % first polymer additive or at least 4 wt. % first polymer additive or at least 4.5 wt. % first polymer additive or at least 5 wt. % first polymer additive or at least 5.5 wt. % first polymer additive or at least 6 wt. % polymer additive for a total weight of the blend.

Embodiment 39. The blend of embodiment 1, wherein the asphalt blend comprises a first polymer additive content of not greater than 10 wt. % first polymer additive for a total weight of the blend or not greater than 9 wt. % first polymer additive or not greater than 8 wt. % first polymer additive or not greater than 7 wt. % first polymer additive or not greater than 6 wt. % first polymer additive or not greater than 5 wt. % first polymer additive for a total weight of the blend.

Embodiment 40. The blend of embodiment 24, wherein the asphalt blend comprises a second polymer additive content of at least 1 wt. % second polymer additive content for a total weight of the blend or at least 1.5 wt. % second polymer additive or at least 2 wt. % second polymer additive or at least 2.5 wt. % second polymer additive or at least 3 wt. % second polymer additive or at least 3.5 wt. % second polymer additive or at least 4 wt. % second polymer additive or at least 4.5 wt. % second polymer additive or at least 5 wt. % second polymer additive or at least 5.5 wt. % second polymer additive or at least 6 wt. % polymer additive for a total weight of the blend.

Embodiment 41. The blend of embodiment 24, wherein the asphalt blend comprises a second polymer additive content of not greater than 10 wt. % second polymer additive for a total weight of the blend or not greater than 9 wt. % second polymer additive or not greater than 8 wt. % second polymer additive or not greater than 7 wt. % second polymer additive or not greater than 6 wt. % second polymer additive or not greater than 5 wt. % second polymer additive for a total weight of the blend.

Embodiment 42. The blend of embodiment 1, wherein the asphalt blend further comprises a wax.

Embodiment 43. The blend of embodiment 42, wherein the wax comprises a comprises a paraffin wax, an alpha olefin wax, a polyamide wax, an ethylene vinyl acetate (EVA) wax a polypropylene wax, a polyethylene wax or a combination thereof.

Embodiment 44. The blend of embodiment 42, wherein the wax comprises a polypropylene wax.

Embodiment 45. The blend of embodiment 42, wherein the wax comprises a polyethylene wax.

Embodiment 46. The blend of embodiment 42, wherein the wax comprises a polyethylene wax and a polypropylene wax.

Embodiment 47. The blend of embodiment 42, wherein the wax comprises a recycled wax.

Embodiment 48. The blend of embodiment 42, wherein the asphalt blend comprises a wax content of at least 0.5 wt. % wax for a total weight of the blend or at least 1 wt. % or at least 1.5 wt. % or at least 2 wt. %.

Embodiment 49. The blend of embodiment 42, wherein the asphalt blend comprises a wax content of not greater than 10 wt. % or not greater than 5 wt. % or not greater than 4 wt. % or not greater than 3 wt. % or not greater than 2 wt. %.

Embodiment 50. The blend of embodiment 1, wherein the asphalt blend comprises a softening point of at least 200° F. or at least 201° F. or at least 202° F. or at least 203° F. or at least 204° F. or at least 205° F. or at least 206° F. or at least 207° F. or at least 208° F. or at least 209° F. or at least 210° F. or at least 211° F. or at least 212° F. or at least 213° F. or at least 214° F. or at least 215° F.

Embodiment 51. The blend of embodiment 1, further comprising a softening point of not greater than 300° F. or not greater than 290° F. or not greater than 280° F. or not greater than 270° F. or not greater than 260° F. or not greater than 250° F. or not greater than 240° F. or not greater than 230° F. or not greater than 220° F.

Embodiment 52. The blend of embodiment 1, wherein the asphalt blend comprises a softening point differential of less than 6° F. or less than 5.5° F. or less than 5° F. or less than 4.5 OF or less than 4° F. or less than 3.5° F. or less than 3° F.

Embodiment 53. The blend of embodiment 1, wherein the asphalt blend comprises a softening point differential of at least 0.01° F. or at least 0.1° F. or at least 1° F.

Embodiment 54. The blend of embodiment 1, further comprising a penetration at 32° F. of no greater than 20 dmm or no greater than 18 dmm or no greater than 16 dmm or no greater than 14 dmm or no greater than 13 dmm or no greater than 12 dmm.

Embodiment 55. The blend of embodiment 1, further comprising a penetration at 32° F. of at least 5 dmm or at least 6 dmm or at least 7 dmm or at least 8 dmm or at least 9 dmm or at least 10 dmm or at least 11 dmm or at least 12 dmm.

Embodiment 56. The blend of embodiment 1, further comprising a penetration at 77° F. of no greater than 40 dmm or no greater than 39 dmm or no greater than 38 dmm or no greater than 37 dmm or no greater than 36 dmm or no greater than 35 dmm or no greater than 34 dmm or no greater than 33 dmm or no greater than 32 dmm.

Embodiment 57. The blend of embodiment 1, further comprising a penetration at 77° F. of at least 21 dmm or at least 22 dmm or at least 23 dmm or at least 24 dmm or at least 25 dmm or at least 26 dmm or at least 27 dmm or at least 28 dmm or at least 29 dmm or at least 30 dmm or at least 31 dmm or at least 32 dmm.

Embodiment 58. The blend of embodiment 1, further comprising a penetration at 115° F. of no greater than 92 dmm or no greater than 91 dmm or no greater than 90 dmm or no greater than 89 dmm or no greater than 88 dmm or no greater than 87 dmm or no greater than 86 dmm or no greater than 85 dmm or no greater than 84 dmm.

Embodiment 59. The blend of embodiment 1, further comprising a penetration at 115° F. of at least 21 dmm or at least 22 dmm or at least 23 dmm or at least 24 dmm or at least 25 dmm or at least 26 dmm or at least 27 dmm or at least 28 dmm or at least 29 dmm or at least 30 dmm or at least 31 dmm.

Embodiment 60. The blend of embodiment 1, further comprising a viscosity at 400° F. of at least 360 cps or at least 370 cps or at least 380 cps or at least 390 cps or at least 400 cps or at least 410 cps or at least 420 cps.

Embodiment 61. The blend of embodiment 1, further comprising a viscosity at 400° F. of no greater than 800 cps or no greater than 750 cps or no greater than 700 cps or no greater than 650 cps or no greater than 600 cps or no greater than 550 cps or no greater than 500 cps or no greater than 450 cps.

Embodiment 62. A method of preparing an asphalt blend comprising,
providing the asphalt, polymer additive, and optionally a wax,
mixing the asphalt and polymer additive to prepare an intermediate asphalt blend,
providing ground tire rubber,
mixing the intermediate asphalt blend and the ground tire to prepare an asphalt blend.

Embodiment 63. The method of embodiment 62, wherein the asphalt blend comprises the blend of any of embodiments 1-61.

Embodiment 64. The method of embodiment 62, wherein mixing to prepare an intermediate asphalt blend is done at a temperature of at least 325° F. or at least 330° F. or at least 345° F. or at least 350° F. or at least 355° F. or at least 360° F. or at least 365° F.

Embodiment 65. The method of embodiment 62, wherein mixing to prepare an intermediate asphalt blend is done at a temperature of no greater than 425° F. or no greater than 420° F. or no greater than 415° F. or no greater than 410° F. or no greater than 405° F. or no greater than 400° F. or no greater than 395° F. or no greater than 390° F. or no greater than 385° F.

Embodiment 66. The method of embodiment 62, wherein mixing to prepare an asphalt blend is done at a temperature 325° F. or at least 330° F. or at least 345° F. or at least 350° F. or at least 355° F. or at least 360° F. or at least 365° F.

Embodiment 67. The method of embodiment 62, wherein mixing to prepare an asphalt blend is done at a temperature of no greater than 425° F. or no greater than 420° F. or no greater than 415° F. or no greater than 410° F. or no greater than 405° F. or no greater than 400° F. or no greater than 395° F. or no greater than 390° F. or no greater than 385° F.

Embodiment 68. The method of embodiment 62, wherein mixing to prepare an intermediate asphalt blend is done with high shear mixing.

Embodiment 69. The method of embodiment 62, wherein mixing to prepare an intermediate asphalt blend is done with a homogenizer or rotor stator mixer.

Embodiment 70. The method of embodiment 69, where high shear mixing comprises mixing with a shear rate of at least 10,000 s⁻¹.

Embodiment 71. The method of embodiment 69, wherein the homogenizer or rotor stator mixer is operated with a speed of at least 2500 rpm or at least 2600 rpm or at least 2700 rpm or at least 2800 rpm or at least 2900 rpm or at least 3000 rpm.

Embodiment 72. The method of embodiment 69, wherein the homogenizer or rotor stator mixer is operated with a speed of no greater than 4500 rpm or no greater than 4400 rpm or no greater than 4300 rpm or no greater than 4200 rpm or no greater than 4100 rpm or no greater than 4000 rpm.

Embodiment 73. The method of embodiment 62, wherein mixing to prepare an asphalt blend is done with low shear mixing.

Embodiment 74. The method of embodiment 73, where low shear mixing comprises mixing with a shear rate of no greater than 10,000 s⁻¹.

Embodiment 75. The method of embodiment 62, wherein mixing to prepare an asphalt blend is done with a paddle blade mixer.

Embodiment 76. The method of embodiment 73, wherein the paddle blade mixer is operated with a speed of at least 400 rpm or at least 450 rpm or at least 500 rpm or at least 550 rpm or at least 600 rpm or at least 650 rpm or at least 700 rpm.

Embodiment 77. The method of embodiment 73, wherein the paddle blade mixer is operated with a speed of no greater than 1600 rpm or no greater than 1500 rpm or no greater than 1400 rpm or no greater than 1300 rpm or no greater than 1200 rpm or no greater than 1100 rpm or no greater than 1000 rpm or no greater than 900 rpm or no greater than 800 rpm.

Embodiment 78. The method of embodiment 62, wherein the mixture reaches a steady state viscosity in no greater than 60 minutes of mixing to prepare an asphalt blend or no greater than 58 minutes or no greater than 56 minutes or no greater than 54 minutes or no greater than 52 minutes or no greater than 50 minutes or no greater than 48 minutes or no greater than 46 minutes.

Embodiment 79. A filled asphalt mix comprising:
an asphalt blend comprising:
   asphalt,
   a first polymer additive, and
   ground tire rubber having a mesh size of above 80 mesh; and
a filler.

Embodiment 80. The mix of embodiment 79, wherein the asphalt blend comprises the blend of any one of embodiments 1-61.

Embodiment 81. The mix of embodiment 79, wherein the blend comprises an NAF of not greater than 3.0 PLI o or not greater than 2.90 PLI or not greater than 2.80 PLI or not greater than 2.70 PLI or not greater than 2.60 PLI or not greater than 2.50 PLI or not greater than 2.40 PLI or not greater than 2.30 PLI or not greater than 2.20 PLI or not greater than 2.10 PLI or not greater than 2.00 PLI or not greater than 1.90 PLI or not greater than 1.80 PLI or not greater than 1.70 PLI.

Embodiment 82. The mix of embodiment 79, wherein the blend comprises an NAF of at least 0.50 PLI or at least 1.00 PLI or at least 1.50 PLI.

Embodiment 83. The mix of embodiment 79, wherein the filler comprises CaCO₃.

Embodiment 84. The mix of embodiment 79, wherein the filler comprises limestone.

Embodiment 85. The mix of embodiment 79, wherein the composition comprises a filler content of at least 40 wt. % filler for a total weight of the mix or at least 42 wt. % or at least 44 wt. % or at least 46 wt. % or at least 48 wt. % or at least 50 wt. % or at least 52 wt. % or at least 54 wt. % or at least 56 wt. % or at least 58 wt. % or at least 60 wt. % or at least 62 wt. % or at least 64 wt. % or at least 66 wt. % or at least 68 wt. % or at least 70 wt. % or at least 72 wt. % or at least 74 wt. % or at least 76 wt. % or at least 78 wt. % or at least 80 wt. %.

Embodiment 86. The mix of embodiment 79, wherein the composition comprises a filler content of not greater than 90 wt. % filler for a total weight of the mix or not greater than 88 wt. % or not greater than 86 wt. % or not greater than 84 wt. % or not greater than 82 wt. % or not greater than 80 wt. % or not greater than 78 wt. % or not greater than 76 wt. % or not greater than 74 wt. % or not greater than 72 wt. % or not greater than 70 wt. %.

Embodiment 87. The mix of embodiment 79, wherein the asphalt mix comprises a softening point of at least 250° F. or at least 251° F. or at least 252° F. or at least 253° F. or at least 254° F. or at least 255° F. or at least 256° F. or at least 257° F. or at least 258° F. or at least 259° F. or at least 260° F. or at least 261° F. or at least 262° F. or at least 263° F. or at least 264° F. or at least 265° F. or at least 266° F. or at least 267° F. or at least 268° F.

Embodiment 88. The mix of embodiment 79, further comprising a softening point of not greater than 325° F. or not greater than 320° F. or not greater than 315° F. or not greater than 310 OF or not greater than 305° F. or not greater than 300° F. or not greater than 295° F. or not greater than 290° F. or not greater than 285° F. or not greater than 280° F. or not greater than 275° F. or not greater than 270° F.

Embodiment 89. The mix of embodiment 79, further comprising a penetration at 32° F. of no greater than 10 dmm or no greater than 9 dmm or no greater than 8 dmm or no greater than 7 dmm or no greater than 6 dmm or no greater than 5 dmm or no greater than 4 dmm.

Embodiment 90. The mix of embodiment 79, further comprising a penetration at 32° F. of at least 1 dmm or at least 2 dmm or at least 3 dmm or at least 4 dmm or at least 5 dmm or at least 6 dmm or at least 7 dmm.

Embodiment 91. The mix of embodiment 79, further comprising a penetration at 77° F. of no greater than 20 dmm or no greater than 19 dmm or no greater than 18 dmm or no greater than 17 dmm or no greater than 16 dmm or no greater than 15 dmm or no greater than 14 dmm.

Embodiment 92. The mix of embodiment 79, further comprising a penetration at 77° F. of at least 1 dmm or at least 2 dmm or at least 3 dmm or at least 4 dmm or at least 5 dmm or at least 6 dmm or at least 7 dmm or at least 8 dmm or at least 9 dmm or at least 10 dmm or at least 11 dmm or at least 12 dmm or at least 13 dmm.

Embodiment 93. The mix of embodiment 79, further comprising a penetration at 115° F. of no greater than 40 dmm or no greater than 39 dmm or no greater than 38 dmm or no greater than 37 dmm or no greater than 36 dmm or no greater than 35 dmm or no greater than 34 dmm or no greater than 33 dmm or no greater than 32 dmm or no greater than 31 dmm or no greater than 30 dmm.

Embodiment 94. The mix of embodiment 79, further comprising a penetration at 115° F. of at least 21 dmm or at least 22 dmm or at least 23 dmm or at least 24 dmm or at least 25 dmm or at least 26 dmm or at least 27 dmm or at least 28 dmm or at least 29 dmm or at least 30 dmm.

Embodiment 95. The mix of embodiment 79, further comprising a viscosity at 400° F. of at least 3600 cps or at least 3700 cps or at least 3800 cps or at least 3900 cps or at least 4000 cps or at least 4100 cps or at least 4200 cps or at least 4300 cps or at least 4400 cps or at least 4500 cps or at least 4600 cps or at least 4700 cps or at least 4800 cps or at least 4900 cps or at least 5000 cps or at least 5100 cps or at least 5200 cps or at least 5300 cps.

Embodiment 96. The mix of embodiment 79, further comprising a viscosity at 400° F. of no greater than 8000 cps or no greater than 7500 cps or no greater than 7000 cps or no greater than 6500 cps or no greater than 6000 cps or no greater than 5500 cps or no greater than 5000 cps or no greater than 4500 cps.

Embodiment 97. The method of preparing a filled asphalt mix,
providing the asphalt, polymer additive, and optionally a wax,
mixing the asphalt and polymer additive to prepare an intermediate asphalt blend,
providing ground tire rubber,
mixing the intermediate asphalt blend and the ground tire to prepare an asphalt blend, providing a filler,
mixing the asphalt blend and the filler to prepare a filled asphalt mix.

Embodiment 98. The method of embodiment 97, wherein the asphalt blend comprises the blend of any of embodiments 1-61.

Embodiment 99. The method of embodiment 97, wherein the filled asphalt mix comprises the mix of embodiments 79-96.

Embodiment 100. The method of embodiment 97, wherein mixing to prepare an intermediate asphalt blend is done at a temperature of at least 325° F. or at least 330° F. or at least 345° F. or at least 350° F. or at least 355° F. or at least 360° F. or at least 365° F.

Embodiment 101. The method of embodiment 97, wherein mixing to prepare an intermediate asphalt blend is done at a temperature of no greater than 425° F. or no greater than 420° F. or no greater than 415° F. or no greater than 410° F. or no greater than 405° F. or no greater than 400° F. or no greater than 395° F. or no greater than 390° F. or no greater than 385° F.

Embodiment 102. The method of embodiment 97, wherein mixing to prepare an asphalt blend is done at a temperature of 325° F. or at least 330° F. or at least 345° F. or at least 350° F. or at least 355° F. or at least 360° F. or at least 365° F.

Embodiment 103. The method of embodiment 97, wherein mixing to prepare an asphalt blend is done at a temperature of no greater than 425° F. or no greater than 420° F. or no greater than 415° F. or no greater than 410° F. or no greater than 405° F. or no greater than 400° F. or no greater than 395° F. or no greater than 390° F. or no greater than 385° F.

Embodiment 104. The method of embodiment 97, wherein mixing to prepare an intermediate asphalt blend is done with high shear mixing.

Embodiment 105. The method of embodiment 97, wherein mixing to prepare an intermediate asphalt blend is done with a homogenizer or rotor stator mixer.

Embodiment 106. The method of embodiment 105, wherein the homogenizer or rotor stator mixer is operated with a speed of at least 2500 rpm or at least 2600 rpm or at least 2700 rpm or at least 2800 rpm or at least 2900 rpm or at least 3000 rpm.

Embodiment 107. The method of embodiment 105, wherein the homogenizer or rotor stator mixer is operated with a speed of no greater than 4500 rpm or no greater than 4400 rpm or no greater than 4300 rpm or no greater than 4200 rpm or no greater than 4100 rpm or no greater than 4000 rpm.

Embodiment 108. The method of embodiment 97, wherein mixing to prepare an asphalt blend is done with low shear mixing.

Embodiment 109. The method of embodiment 97, wherein mixing to prepare an asphalt blend is done with a paddle blade mixer.

Embodiment 110. The method of embodiment 109, wherein the paddle blade mixer is operated with a speed of at least 400 rpm or at least 450 rpm or at least 500 rpm or at least 550 rpm or at least 600 rpm or at least 650 rpm or at least 700 rpm.

Embodiment 111. The method of embodiment 109, wherein the paddle blade mixer is operated with a speed of no greater than 1600 rpm or no greater than 1500 rpm or no greater than 1400 rpm or no greater than 1300 rpm or no greater than 1200 rpm or no greater than 1100 rpm or no greater than 1000 rpm or no greater than 900 rpm or no greater than 800 rpm.

Embodiment 112. The method of embodiment 97, wherein the asphalt blend reaches a steady state viscosity in no greater than 60 minutes of mixing to prepare an asphalt blend or no greater than 58 minutes or no greater than 56 minutes or no greater than 54 minutes or no greater than 52 minutes or no greater than 50 minutes or no greater than 48 minutes or no greater than 46 minutes.

Embodiment 113. The method of embodiment 97, wherein mixing to prepare a filled asphalt mix is done at a temperature of at least 350° F. or at least 360° F. or at least 370° F. or at least 380° F. or at least 390° F.

Embodiment 114. The method of embodiment 97, wherein mixing to prepare a filled asphalt mix is done at a temperature of no greater than 450° F. or no greater than 440° F. or no greater than 430° F. or no greater than 420° F. or no greater than 410° F.

Embodiment 115. A roofing shingle comprising:
a fiberglass mat;
an asphalt composition coating the fiberglass mat, the composition comprising the asphalt mix of any one of embodiments 79-96.

Embodiment 116. A bundle of packaged roofing shingles according to embodiment 115.

Embodiment 117. The bundle of embodiment 116, comprising at least 10 shingles or at least 11 shingles or at least 12 shingles or at least 13 shingles or at least 14 shingles or at least 15 shingles or at least 16 shingles or at least 17 shingles or at least 18 shingles or at least 19 shingles or at least 20 shingles.

Embodiment 118. The bundle of embodiment 116, comprising no greater than 30 shingles or no greater than 28 shingles or no greater than 26 shingles or no greater than 24 shingles or no greater than 22 shingles.

Embodiment 119. A palleted plurality of roofing shingles comprising a plurality of roofing shingles disposed in one or more stacks on a pallet, wherein the pallet has a top surface formed of a plurality of top boards, and wherein:
(a) adjacent boards of the plurality of top boards have a gap of no more than one inch therebetween at the top surfaces thereof; and/or
(b) the plurality of top boards take up at least 85% of the occluded area of the top surface of the pallet;
(c) each of the plurality of top boards has a thickness of at least 0.55 inches, and wherein each roofing shingle has an upper edge, a lower edge, a first end, and a second end, each roofing shingle comprising a shingle according to embodiment 115.

Embodiment 120. The palleted plurality of shingles of embodiment 119, where the stacks of shingles comprises bundles of shingles according to embodiments 116-118.

Embodiment 121. The palleted plurality of shingles of embodiment 119, wherein the pallet comprises 3-5 stacks.

Embodiment 122. The palleted plurality of shingles of embodiment 119, wherein the pallet comprises 4 stacks.

Embodiment 123. The palleted plurality of shingles of embodiment 120, wherein each stack comprises at least 6 bundles or at least 7 bundles or at least 8 bundles or at least 9 bundles or at least 10 bundles or at least 11 bundles or at least 12 bundles.

Embodiment 124. The palleted plurality of shingles of embodiment 120, wherein each stack comprises no greater than 16 bundles or no greater than 15 bundles or no greater than 14 bundles or no greater than 13 bundles or no greater than 12 bundles.

### EXAMPLES

### Example 1-GTR Size and Mixing

A standard American Stainless-Steel quart can Dimensions: 4.25″ Dia.×4.875″ H was partially filled with 300 g of paving grade PG 64-22 asphalt. The can and asphalt were then heated to a temperature of at least 350° F. and mixed using a Greerco 1L-87 1/2HP High Shear homogenizer/rotor stator mixer and mixed on low power to heat the mixing head. SBS Polymer and wax were added according to Table 1 below. The wax was a recycled polyethylene wax. The polymer was a radial triblock SBS polymer with a styrene content of 35% and a mid-block vinyl content of 40%.

The minimum temperature was increased to 365° F. and the blend was mixed for 1 hour at 3000 to 4000 rpm. During mixing, the temperature was kept within a range of 365° F. to 385° F.

Proper mixing can be confirmed by using a UV microscope to determine if a polymer network is fully formed. Proper mixing can also be tested using a smear test where a sample is spread across a flat surface to determine if there are any unmixed particles.

The can of polymer and waxed modified asphalt were then moved to a FisherBrand Overhead Stirrer MFR Num 14-500-210 equipped with a Caframo Pitched Blade 2″ diameter Turbine (Mfr #5080156). Ground tire rubber was then added to the asphalt blend and mixed at a speed of 750 RPM for 15 minute increments at a temperature of 365° F. to 385° F. After each 15 minute increment, the viscosity was measured according to ASTM D4402-06. Results can be found in Table 1 below.

TABLE 1

| | | |
|---|---|---|
| Sample | CS1 | S1 |

Asphalt Blends

| | | |
|---|---|---|
| PG 64-22 Asphalt | 88.0% | 88.0% |
| SBS | 4.5% | 4.5% |
| Wax | 2.5% | 2.5% |
| GTR 40 mesh | 5.0% | 0% |
| GTR 140 Mesh | 0% | 5.0% |

Viscosity at 400° F. (cps)

| | | |
|---|---|---|
| 0 minutes | 187 | 185 |
| 15 minutes | 313 | 326 |
| 30 minutes | 320 | 343 |
| 45 minutes | 336 | 370 |
| 60 minutes | 345 | 370 |

### Example 2-GTR Phase Separation

A standard American Stainless-Steel quart can Dimensions: 4.25″ Dia.×4.875″ H was partially filled with 300 g of paving grade PG 64-22 asphalt. The can of asphalt was then moved to a FisherBrand Overhead Stirrer MFR Num 14-500-210 equipped with a Caframo Pitched Blade 2″ diameter Turbine (Mfr #5080156). Ground tire rubber was then added to the asphalt and mixed at a speed of 750 RPM for 15-minute increments at a temperature of 365° F. to 385° F.

The modified cigar tube test, ASTM D 7173, “Standard Practice for Determining the Separation Tendency of Polymer from Polymer-Modified Asphalt,” was used to evaluate the storage stability of the blend. After blending for 20 minutes, 60 ml samples were poured into a metal tube (cigar tubes of 25 mm diameter and 125 mm height) and set vertically at 400° F. for 24 hours, with the top of the tube sealed to block the air and prevent asphalt oxidation. This conditioning provides time to phase separate if there is a tendency to do so. After 24 hours, blends were quenched with liquid nitrogen to freeze the phase. Softening point tests according to ASTM D3461-18 were performed on samples collected from the top and the bottom of the tube. Softening point differential can be calculated by taking the average absolute values of the difference in results between top and bottom samples. See the sample calculation of the PG 64-22 below.

$$\frac{( \vert ( 12 \; 0.3 + 121.6 ) - ( 122.0 + 121 \text{.7} ) \vert )}{2} = 1.8$$

TABLE 2

| | | | | Softening |
|---|---|---|---|---|
| Softening | GTR | | | Point |
| point (F.) | Size | Top sample | Bottom Sample | Differential |
| PG 64-22 | N/A | 120.3, 121.6 | 122.0, 121.7 | 1.8 |
| CS2 | 40 Mesh | 124.0, 123.9 | 129.7, 130.6 | 6.2 |
| S2 | 140 Mesh | 132.0, 131.9 | 133.7, 136.1 | 2.95 |

### Example 3—GTR Mixing Methods

TABLE 3
Sample Compositions

| | |
|---|---|
| PG 64-22 Asphalt | 88.0% |
| SBS | 4.5% |
| Wax | 2.5% |
| GTR 140 Mesh | 5.0% |

### Mixing Method 1—High Shear Polymer and Wax First; Low Shear GTR Second

A standard American Stainless-Steel quart can Dimensions: 4.25″ Dia.×4.875″ H was partially filled with paving grade PG 64-22 asphalt. The can and asphalt were then heated to a temperature of at least 350° F. and mixed using Greerco 1L-87 1/2HP High Shear homogenizer/rotor stator mixer and mixed on low power to heat the mixing head. SBS Polymer and wax are added according to Table 3 above.

The minimum temperature was increased to 365° F. and the blend was mixed for 1 hour at 3000 to 4000 rpm. During mixing, the temperature was kept within a range of 365° F. to 385° F.

Proper mixing can be confirmed by using a UV microscope to determine if a polymer network is fully formed. Proper mixing can also be tested using a smear test where a sample is spread across a flat surface to determine if there are any unmixed particles.

The can of polymer and waxed modified asphalt was then moved to a FisherBrand Overhead Stirrer MFR Num 14-500-210 equipped with a Caframo Pitched Blade 2″ diameter Turbine (Mfr #5080156). 140 mesh ground tire rubber was then added to the asphalt blend and mixed at a speed of 750 RPM for 15 minutes at a temperature of 365° F. to 385° F. Two samples S3 were produced according to this process. After blending, the viscosity was measured according to ASTM D4402-06. Results can be found in Table 4 below.

### Mixing Method 2—High Shear GTR First; High Shear Polymer and Wax Second

A standard American Stainless-Steel quart can Dimensions: 4.25″ Dia.×4.875″ H was partially filled with paving grade PG 64-22 asphalt. The can and asphalt were then brought to a temperature of at least 350° F. and mixed using a Greerco 1L-87 1/2HP High Shear homogenizer/rotor stator mixer and mixed on low power to heat the mixing head. 140 Mesh GTR was added according to Table 3 above.

The minimum temperature was increased to 365° F. and the blend is mixed for 1 hour at 3000 to 4000 rpm. During mixing, the temperature is kept within a range of 365° F. to 385° F.

Next the SBS Polymer and wax were added according to Table 3 above and again mixed for 1 hour at 3000 to 4000 RPM with the homogenizer/rotor stator mixer. During mixing, the temperature was kept within a range of 365° F. to 385° F. After blending, the viscosity was measured according to ASTM D4402-06. Two samples CS3 were produced according to this process. Results can be found in Table 4 below.

### Mixing Method 3—Low Shear GTR First; High Shear Polymer and Wax Second

A standard American Stainless-Steel quart can Dimensions: 4.25″ Dia.×4.875″ H was partially filled with paving grade PG 64-22 asphalt. The can of asphalt was then moved to a FisherBrand Overhead Stirrer MFR Num 14-500-210 equipped with a Caframo Pitched Blade 2″ diameter Turbine (Mfr #5080156). 140 mesh ground tire rubber was then added to the asphalt blend and mixed at a speed of 750 RPM for 15 minutes at a temperature of 365° F. to 385° F.

The can and asphalt were then brought to a temperature of at least 350° F. and mixed using Greerco 1L-87 1/2HP High Shear homogenizer/rotor stator mixer and mixed on low power to heat the mixing head. SBS Polymer and wax were added according to Table 3 above.

The minimum temperature was increased to 365° F. and the blend was mixed for 1 hour at 3000 to 4000 rpm. During mixing, the temperature was kept within a range of 365° F. to 385° F.

After blending, the viscosity was measured according to ASTM D4402-06. Two samples CS4 were produced according to this process. Results can be found in Table 4 below.

TABLE 4

| Sample | Viscosity | Viscosity |
|---|---|---|
| S3 | 463 | 463 |
| CS3 | 875 | 865 |
| CS4 | 687 | 615 |

### Example 4—Unfilled GTR Compositions

A standard American Stainless-Steel quart can Dimensions: 4.25″ Dia.×4.875″ H was partially filled with 300 g of paving grade PG 64-22 asphalt. The can and asphalt were then heated to a temperature of at least 350° F. and mixed using a Greerco 1L-87 1/2HP High Shear homogenizer/rotor stator mixer and mixed on low power to heat the mixing head. SBS Polymer and wax were added according to Table 5 below. The wax was a recycled polyethylene wax. The polymer was a radial triblock SBS polymer with a styrene content of 35% and a mid-block vinyl content of 40%.

The minimum temperature was increased to 365° F. and the blend was mixed for 1 hour at 3000 to 4000 rpm. During mixing, the temperature was kept within a range of 365° F. to 385° F.

Proper mixing can be confirmed by using a UV microscope to determine if a polymer network is fully formed. Proper mixing can also be tested using a smear test where a sample is spread across a flat surface to determine if there are any unmixed particles.

The can of polymer and waxed modified asphalt was then moved to a FisherBrand Overhead Stirrer MFR Num 14-500-210 equipped with a Caframo Pitched Blade 2″ diameter Turbine (Mfr #5080156). Ground tire rubber was then added to the asphalt blend and mixed at a speed of 750 RPM and a temperature of 375° F. for 15 minutes, producing examples and comparative examples of unfilled asphalt blends.

Unfilled asphalt blends and filled asphalt mixes were evaluated for softening point, penetration, viscosity, and weatherability according to the standard methods in Table 6 below.

TABLE 5
Asphalt Blends

| Sample | CS5 | CS6 | S4 |
|---|---|---|---|
| PG 64-22 Asphalt | 90.0% | 90.0% | 90.0% |
| SBS | 5.0% | 5.0% | 5.0% |
| Ground tire rubber content | 5.0% | 5.0% | 5.0% |
| Ground tire rubber size | 40 mesh | 80 mesh | 140 mesh |
| S. Pt. (F) | 205.3 | 210.8 | 212.4 |
| 32° F. Pen | 11 | 14 | 12 |
| 77° F. Pen | 34 | 33 | 32 |
| 115° F. Pen | 93 | 84 | 84 |
| Vis. @ 400 F. (cps) | 365 | 375 | 428 |

TABLE 6

| Test | ASTM Code | Test Name |
|---|---|---|
| Penetration | ASTM D5-06 | Standard Test Method for Penetration of Bituminous |
| | | Materials |
| Softening | ASTM D3461-18 | Standard Test Method for Softening Point of Asphalt and |
| Point | | Pitch (Mettler Cup-and-Ball Method) |
| Viscosity | ASTM D4402-06 | Standard Test Method for Viscosity Determination of |
| | | Asphalt at Elevated Temperatures Using a Rotational |
| | | Viscometer |
| WOM | D4798M-11(2021) | Standard Practice for Accelerated Weathering Test |
| | ASTM D1670/ | Conditions and Procedures for Bituminous Materials |
| | D1670M-11(2018) | (Xenon-Arc Method) |
| | | ASTM D1670/D1670M-11(2018): Standard Test Method |
| | | for Failure End Point in Accelerated and Outdoor |
| | | Weathering of Bituminous Materials |

### Example 5—Filled GTR

A standard American Stainless-Steel quart can Dimensions: 4.25″ Dia.×4.875″ H was partially filled with 300 g of paving grade PG 64-22 asphalt. The can and asphalt were then heated to a temperature of at least 350° F. and mixed using Greerco 1L-87 1/2HP High Shear Homogenizer/rotor stator mixer and mixed on low power to heat the mixing head. SBS Polymer and wax were added according to Table 5 below. The wax was a recycled polyethylene wax. The polymer was a radial triblock SBS polymer with a styrene content of 35% and a mid-block vinyl content of 40%.

The minimum temperature was increased to 365° F. and the blend was mixed for 1 hour at 3000 to 4000 rpm. During mixing, the temperature was kept within a range of 365° F. to 385° F.

Proper mixing can be confirmed by using a UV microscope to determine if a polymer network is fully formed. Proper mixing can also be tested using a smear test where a sample is spread across a flat surface to determine if there are any unmixed particles.

The can of polymer and waxed modified asphalt was then moved to a FisherBrand Overhead Stirrer MFR Num 14-500-210 equipped with a Caframo Pitched Blade 2″ diameter Turbine (Mfr #5080156). Ground tire rubber was then added to the asphalt blend and mixed at a speed of 750 RPM for 15 minutes, producing unfilled asphalt blends.

Filled examples and comparative examples can be prepared by adding CaCO₃ (Carmeuse filler) to the asphalt blends according to Table 7 and the following process. CaCO₃ and the asphalt mixture are heated to a temperature of 400-415° F. for at least 1 hour. The heated filler was then added to the unfilled asphalt blend and mixed for 15 minutes with the angled paddle blade mixture at 700 RPM for at least 15 minutes to produce filled examples and comparative examples.

Unfilled asphalt blends and filled asphalt mixes were evaluated for softening point, penetration, viscosity, and weatherability according to the standard methods in Table 6 above.

TABLE 7
Filled Asphalt Mixes

| | | | | |
|---|---|---|---|---|
| Sample | CS7 | CS8 | S5 | S6 |

Asphalt Blend Composition

| | | | | |
|---|---|---|---|---|
| PG 64-22 Asphalt | 90.0% | 90.0% | 87.5% | 88.5% |
| SBS | 5.5% | 5.5% | 4% | 4% |
| Wax | 0% | 0% | 2.5% | 2.5% |
| GTR Content | 4.5% | 4.5% | 6.0% | 5.0% |
| GTR Size | 40 mesh | 80 mesh | 140 mesh | 140 mesh |

Filled Asphalt Mix Composition

| | | | | |
|---|---|---|---|---|
| Asphalt Blend | 34% | 34% | 34% | 34% |
| CaCO₃ | 66% | 66% | 66% | 66% |

Filled Asphalt Mix Characteristics

| | | | | |
|---|---|---|---|---|
| S. Pt. (F) | 248.4 | 253.8 | 268.5 | 263.66 |
| 32° F. Pen (dmm) | 3 | 3 | 4 | 4 |
| 77° F. Pen (dmm) | 12 | 12 | 13 | 14 |
| 115° F. Pen (dmm) | 32 | 33 | 30 | 35 |
| Vis. @ 400 F. (cps) | 4610 | 5300 | 4675 | 5000 |

### Example 6—Non-Adhesion

Filled asphalt mixes prepared according to the formulation formulations in table 8 below.

TABLE 8
Filled Asphalt Mixes

| | | |
|---|---|---|
| Sample | CS9 | S7 |

Asphalt Blend Composition

| | | |
|---|---|---|
| PG 64-22 Asphalt | 88.0% | 88.0% |
| SBS | 4.50% | 4.50% |
| Wax | 2.50% | 2.50% |
| GTR Content | 5.00% | 5.00% |
| GTR Size | 80 mesh | 140 mesh |

Filled Asphalt Mix Composition

| | | |
|---|---|---|
| Asphalt Blend | 34% | 34% |
| CaCO₃ | 66% | 66% |

Samples S7 and CS9 underwent non-adhesion testing according to the following process. Samples were heated to 400-420° F. and applied to a glass mat. A metal film applicator was heated to 400-420° F. and a TQC Sheen Art. nr. AB4405 is heated to 125° C. and both were used to apply the asphalt mixes to both sides of the glass mat for a total coating density of 105-130 lb./SQ. The mats were allowed to cool to room temperature. Then the coated mats were cut into 1.5″×3″. pieces. Two of these squares were stacked on top of each other between two ±0.20″ tolerance sheet metal pieces that are also 3″×3″. A weight or clamp was used to apply a pressure of approximately 1-1.2 PSI. Clamped/weighted samples were heated in an oven at 110° F. for 24 hours days. Samples were then removed and allowed to cool for 24 hrs. The weight was removed and samples are inspected visually for deformation and signs of obvious sticking.

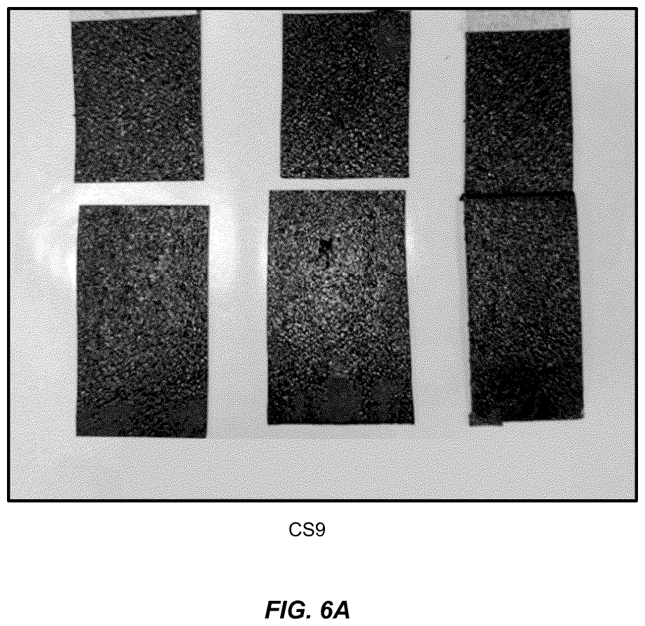

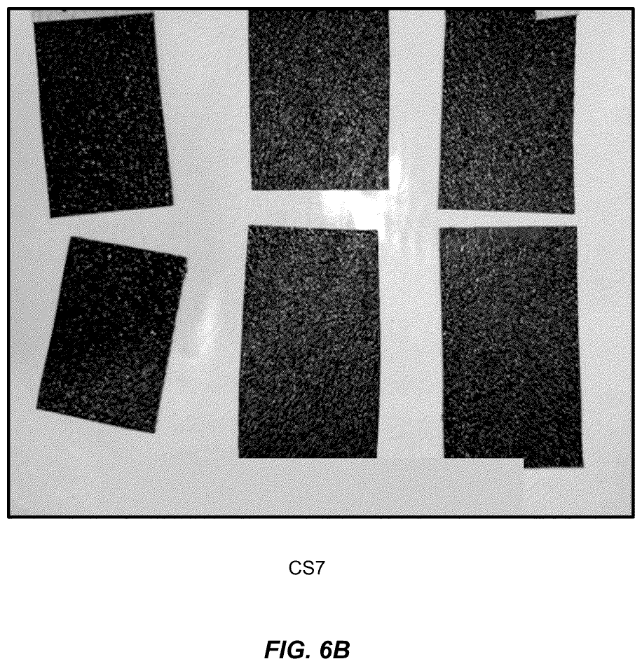

Samples are then peeled using a 3400 Series Instron load frame with 3″ hydraulic clamps at a rate of 2″ per minute. The force of separation is measured and noted as a non-adhesion factor (NAF) and reported below in table 9. Images of the separated shinglets can be found in FIGS. 6a and 6b.

TABLE 9

| Sample | S7 | CS9 |
|---|---|---|
| Average NAF | 1.65 PLI | 3.02 PLI |
| Standard deviation of NAF | 0.05 PLI | 0.12 PLI |

What is claimed is:

1. A filled asphalt mix comprising:
an asphalt blend comprising:
asphalt,
a first polymer additive, and
ground tire rubber having a mesh size of above 80 mesh; and
a filler.

2. The mix of claim 1, wherein the mix comprises an NAF of not greater than 3.0 PLI.

3. The mix of claim 1, wherein the filler comprises limestone.

4. The mix of claim 1, wherein the composition comprises a filler content of at least 40 wt. % filler and not greater than 90 wt. % filler.

5. The mix of claim 1, wherein the asphalt mix comprises a softening point of at least 250° F. and not greater than 320° F.

6. The mix of claim 1, further comprising a penetration at 32° F. of no greater than 10 dmm and at least 1 dmm.

7. The mix of claim 1, further comprising a penetration at 77° F. of no greater than 20 dmm and at least 1 dmm.

8. The mix of claim 1, further comprising a penetration at 115° F. of no greater than 40 dmm and at least 21 dmm.

9. The mix of claim 1, further comprising a viscosity at 400° F. of at least 3600 and no greater than 8000.

10. The mix of claim 1, wherein the asphalt comprises paving grade asphalt.

11. The mix of claim 1, wherein the first polymer additive is a styrene-butadiene-styrene (sbs) polymer.

12. The mix of claim 11, wherein the sbs polymer is a linear sbs polymer, a radial sbs polymer, or a combination thereof.

13. The mix of claim 1, wherein the asphalt blend further comprises a wax.

14. The mix of claim 1, wherein the blend comprises at least 2.0 wt. % ground tire rubber.

15. The mix of claim 1, wherein the wax comprises a comprises a paraffin wax, an alpha olefin wax, a polyamide wax, an ethylene vinyl acetate (EVA) wax a polypropylene wax, a polyethylene wax or a combination thereof.

16. The mix of claim 1, wherein the asphalt blend comprises at least 2.0 wt. % ground tire rubber for a total weight of the blend and not greater than 25 wt. % ground tire rubber for a total weight of the blend.

17. The mix of claim 1, wherein the first polymer additive is a styrene-butadiene-styrene (sbs) polymer.

18. The mix of claim 1, wherein the sbs polymer is a linear sbs polymer, a radial sbs polymer, or a combination thereof.

19. A roofing shingle comprising:
a fiberglass mat;
an asphalt composition coating the fiberglass mat, the composition comprising the asphalt mix of claim 1.

20. A bundle of packaged roofing shingles according to claim 19.
